(19) United States
(12) Patent Application Publication
(10) Pub. No.: US 2003/0063972 A1
(43) Pub. Date: Apr. 3, 2003

(54) Method for preventing miss-process in wafer transfer system

(75) Inventor: Eric Liou, Hsin-Chu (TW)

Correspondence Address: LOWE HAUPTMAN, GILMAN & BERNER, LLP, Suite 310, 1700 Diagonal Road, Alexandria, VA, 22314, US

(73) Assignee: Macronix International Co., Ltd.

(21) Appl. No.: 09/968,004

(22) Filed: Oct. 2, 2001

(51) Int. Cl. B65G 49/02; B65H 1/00

(52) U.S. Cl. 414/806

(57) ABSTRACT

In accordance with the present invention, a method for preventing miss-process in a semiconductor wafer transfer system is provided. The method comprises transferring a pod with a workpiece therein and a tagging system thereon to an interface apparatus. A first signal is sent to an interface apparatus by a host controller to request to lock the pod. Then, the pod is locked on the interface apparatus. Then a tag reader mounted on the interface apparatus reads information from the tagging system. Then, a second signal is sent to a processing tool by the host controller to request to check whether the processing tool is ready, and the workpiece is transferred to the processing tool for process if the processing tool is ready. The present invention avoids miss-operation of changing any unlocked pod during checking if the process tool is ready. Since parameters for the process are determined according to the information read from the tagging system and sent to the host controller, if the pod is manually replaced in the duration of waiting for the processing tool to be ready, miss-process is likely occurred due to the determination of process parameters. Thus, in accordance with the present invention, immediately locking the pod on the interface apparatus once the transfer is completed the possibility of executing miss-process is diminished.

### BACKGROUND OF THE INVENTION

1. Field of the Invention

The present invention generally relates to a method for preventing miss-process in a wafer transfer system, and more particularly to a method for controlling a standardized mechanical interface (SMIF) pod-lock/unlock function of an interface apparatus to prevent miss-process or miss-writing tag data.

2. Description of the Prior Art

The need for reduced cost per unit wafer processed drives the semiconductor industry continuously to search for ways to increase wafer yield and reduce production cycle time. It is well recognized that an overall increase in semiconductor wafer fabrication system productivity is achieved by ensuring a constant supply of wafers at each tool, thus, the transaction capability of the factory material handling system affecting the number of wafer carriers circulating in a factory. As the wafer size has increased, the handling of wafers has become more limited to factory automation, instead of manual handling, to accommodate the increase in size and weight of wafer pods. In other words, the transaction of an interface apparatus transferring a wafer or a wafer cassette into a processing or metrology tool becomes more and more important and complicated.

Semiconductor wafer handling and processing has always required extreme care to avoid contamination due to ambient and process-born particles. Such contamination lowers process yields, thus making the manufacturing of integrated circuits more expensive and time consuming. The standardized mechanical interface (SMIF) system was developed not only to facilitate semiconductor wafer fabrication, but also to reduce particle fluxes onto semiconductor wafers during storage and transport of the wafers through the semiconductor fabrication process. A SMIF system has three main, components: sealed pods used for storing and transporting wafer cassettes, a mini-environment supplied with ultra-clean air flows surrounding cassette load ports and wafer processing areas of processing stations so that the environment inside the pods and mini-environment become miniature clean spaces. Last a robotic transfer assemblies to load/unload wafer cassettes and/or wafers from the sealed pods to the processing toll without contamination of the wafers in the wafer cassette from the external environment. The SMIF system is therefore an effective interface between an operator and the process tool providing a continuous, ultra-clean environment for the wafers as they move through the wafer fab.

Recently, robotic apparatus and other machines having a SMIF apparatus is designed to integrate wafer cassette loading and unloading into a wafer processing and metrology tools. Thus, the operation interface is becoming more complicated. For identifying and locating various partially finished products contained in the pods, the pods are labeled with a tag or a tagging system positioned on the side of the pod. Each pod includes an electrical tag which stores information identifying the particular wafer lot within the pod, and the particular processes to be performed on the lot. The tag can be read automatically by a tag reader, which is normally mounted on the interface apparatus. Each tag reader has an output cable for outputting the data it reads. For example, a wafer lot may be tracked at its various locations around a wafer fab, and may be controlled with respect to which processes are performed on the lot.

In accordance with the conventional factory automation of wafer handling methods, a pod such as SMIF pod having a tag thereon and a wafer lot therein is transferred to an interface apparatus, such as a SMIF indexer. A tag reading system usually mounted on the interface apparatus reads the tag of the wafer lot and changes the tag data if the lot is about to be processed. That is, the information about identifying the particular wafer lot within the pod and the particular processes to be performed on the lot is read and changed by the tag reader. After detecting a processing tool in an operational status and a processing command is executed, the processing tool is ready to process wafers, the SMIF pod is locked and the wafer lot within the pod is loaded into the processing tool. Therefore, a risk of miss-process exists due to the lack of control of the SMIF pod in the duration of checking the operational status of the processing tool before the pod is locked. An operator may perform an improper operation, such as taking the pod out and replacing it with another, this results in a miss-process that leads to yield lost or, more seriously, the whole lot of wafers are scraped. Thus, it is desired to provide a method for preventing miss-process in a wafer transfer system.

### SUMMARY OF THE INVENTION

The present invention is directed towards a method for preventing miss-process in a wafer transfer system, which takes full control of a pod by controlling pod-lock/unlock function of an interface apparatus while waiting for a processing tool's preparation. The key aspect of the present invention is to lock the pod immediately when it is transferred to the interface apparatus eliminating the possibility of improper handling of the pod. The present invention avoids miss-operation of changing any unlocked pod during checking if the process tool is ready. Since parameters for the process are determined according to the information read from the tagging system and sent to the host controller, if the pod is manually replaced in the duration of waiting for the processing tool to be ready, miss-process is likely occurred due to the determination of process parameters. Thus, in accordance with the present invention, immediately locking the pod on the interface apparatus once the transfer is completed the possibility of executing miss-process is diminished.

In accordance with the present invention, in one embodiment, a method for preventing miss-process in a semiconductor wafer transfer system is provided. The method comprises transferring a pod with a workpiece therein and a tagging system thereon to an interface apparatus, sending a first signal to an interface apparatus by a host controller to request to lock the pod, locking the pod on the interface apparatus, reading information from the tagging system by a tag reader mounted on the interface apparatus, sending a second signal to a processing tool by the host controller to request to check whether the processing tool is ready, and transferring the workpiece to the processing tool if the processing tool is ready for process. The interface apparatus comprises a standardized mechanical interface (SMIF) apparatus. The step of sending the first signal comprises sending the first signal to a first controller of the interface apparatus by the host controller to request to lock the pod through a SECS II communication protocol. The method further comprises outputting the tag information and changing the tag data by the tag reader when the tag information is read.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a wafer transfer system using communication links among an interface apparatus, a processing tool, and a host controller; and

FIG. 2 is a flowchart of wafer handling by the wafer transfer system in accordance with the present invention.

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

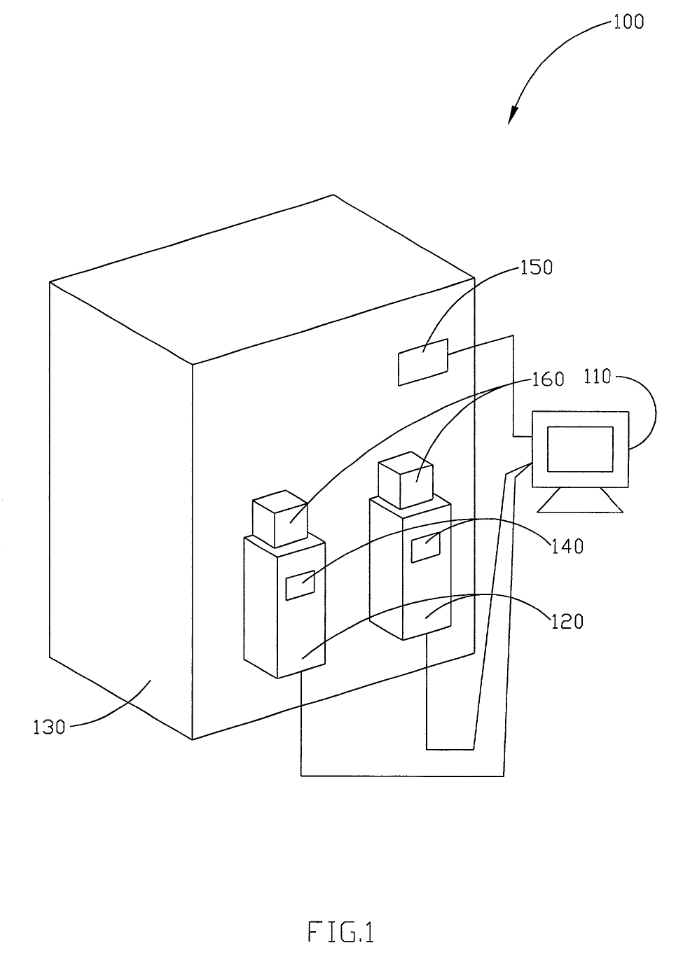

In one embodiment, in accordance with the present invention, a method for preventing miss-process in a semiconductor wafer transfer system is provided, which takes full control of a pod by controlling pod-lock/unlock function of an interface apparatus for the duration of waiting for a processing tool's readiness. The semiconductor wafer transfer system comprises a host controller, a processing tool, and an interface apparatus. FIG. 1 illustrates a schematic diagram of the wafer transfer system 100 using communication links among the host controller 110, the interface apparatus 120, and the processing tool 130. The interface apparatus 120, which can be a SMIF apparatus such as SMIF indexer, includes a first controller 140 that is connected to and controlled by the host controller 110. The host controller 110 through a second controller 150 simultaneously controls the processing tool 130. The host controller 110 communicates with the first controller 140 and the second controller 150 according to a Semiconductor Equipment Communication Standard (SECS) established by Semiconductor Equipment and Material International (SEMI). Additionally, in some cases, the second controller 150 is combined with the lock/unlock function of SMIF indexer, thus, the host controller issued the lock/unlock command through the second controller 150, and the first controller is for reading or writing the tag information.

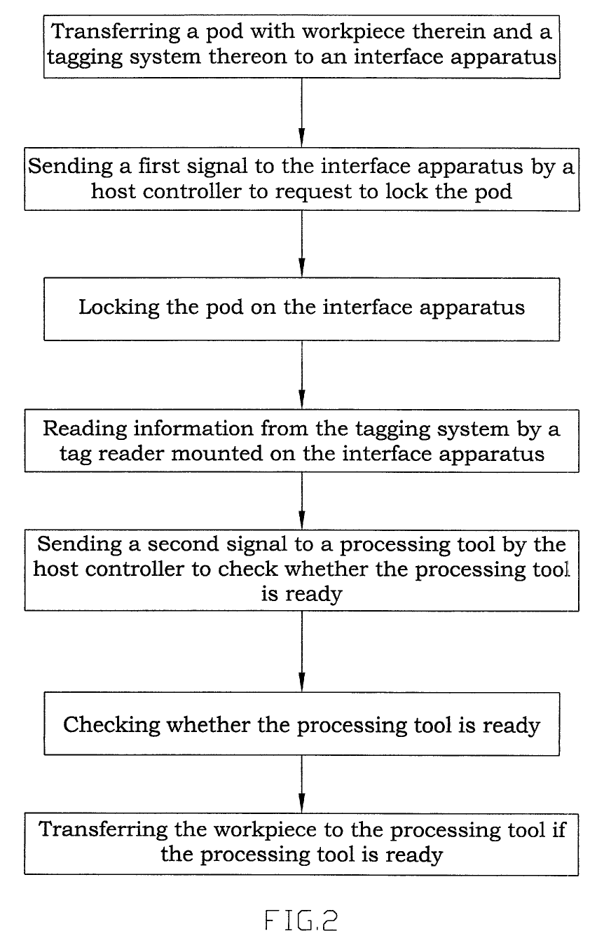

Also referring to FIG. 2, a flowchart of wafer handling by the wafer transfer system in accordance with the present invention is illustrated. The method comprises the step of transferring a pod 160 with a workpiece therein and a tagging system thereon to an interface apparatus. The workpiece can be a semiconductor-wafer-carrying cassette including one or more semiconductor wafers. In the case of processing semiconductor wafers, the workpiece is usually a plurality of wafers loaded into a cassette, which is placed into a pod 160, such as a SMIF pod. The cassette is loaded into the bottom end of the pod 160 since the top is sealed off to reduce the possibility of contamination. The pod 160 is also equipped with a tagging system for the automated identification and recognition of wafers contained in the pod to prevent miss-process, and to track the product-lot serial numbers through the host controller 150.

When the pod 160 is transferred to the interface apparatus 120, a host controller 110 sends a first signal to the first controller 140 of the interface apparatus 120 to request to lock the pod 160 through a SECS II communication protocol. Then, the pod 160 is locked on the interface apparatus 120. A tag reader mounted on the interface apparatus 120 reads information from the tagging system on the pod 160 to identify the workpiece contained in the pod 160, to output the information, and to change the tag data, thereby process parameters of this specific workpiece is determined. When the pod 160 is locked and information of the workpiece is identified, the host controller 110 sends a second signal to the second controller 150 of the processing tool 110 to request to check whether the processing tool 110 is ready. After the processing tool 110 is checked, the workpiece is transferred to the processing tool 110 if the processing tool 110 is ready.

The method further comprises when the workpiece is processed and transferred back to the pod 160, the pod 160 is unlocked for other operations. Thus, in accordance with the present invention, the pod is under full control by controlling pod-lock/unlock function of the interface apparatus for the duration of waiting for a processing tool to be ready. The key aspect of the present invention is to lock the pod immediately when it is transferred to the interface apparatus to ensure the control over the pod and to eliminate the possibility of improper handling with the pod, such that prevents miss-process. The present invention avoids miss-operation of changing any unlocked pod during checking if the process tool is ready. Since parameters for the process are determined according to the information read from the tagging system and sent to the host controller, if the pod is manually replaced in the duration of waiting for the processing tool to be ready, miss-process is likely occurred due to the determination of process parameters. Thus, in accordance with the present invention, immediately locking the pod on the interface apparatus once the transfer is completed the possibility of executing miss-process is diminished.

Although specific embodiments have been illustrated and described, it will be obvious to those skilled in the art that various modifications may be made without departing from what is intended to be limited solely by the appended claims.

What is claimed is:

1. A method for preventing miss-process in a semiconductor workpiece transfer system, said method comprising:
transferring a pod with a workpiece therein and a tagging system thereon to an interface apparatus;
locking said pod on said interface apparatus;
checking whether a processing tool is ready; and
transferring said workpiece to said processing tool if said processing tool is ready.

2. The method according to claim 1, further comprising when said pod is transferred to said interface apparatus, sending a signal to said interface apparatus to request to lock said pod.

3. The method according to claim 1, further comprising when said pod is transferred to said interface apparatus, sending a signal to said processing tool requesting to lock said pod through a SECS II communication protocol.

4. The method according to claim 1, wherein said interface apparatus comprises a tag reader, and when the pod is locked, said tag reader mounted on said interface apparatus reads information from said tagging system.

5. The method according to claim 1, further comprising when the pod is locked, a tag reader mounted on said interface apparatus reads, outputs, and changes information of said tagging system.

6. A method for preventing miss-process in a semiconductor wafer transfer system, said method comprising:
transferring a pod with a plurality of wafers therein and a tagging system thereon to a standardized mechanical interface (SMIF) apparatus;
sending a signal to said standardized mechanical interface (SMIF) apparatus by a host controller to request to lock said pod;
locking said pod on said standardized mechanical interface (SMIF) apparatus;
reading information from said tagging system by a tag reader mounted on said standardized mechanical interface (SMIF) apparatus;
checking whether a processing tool is ready; and
transferring said wafers to said processing tool if said processing tool is ready.

7. The method according to claim 6, wherein said step of sending said signal comprises sending said signal to a controller of said standardized mechanical interface (SMIF) apparatus to request to lock said pod.

8. The method according to claim 6, further comprising said tag reader mounted on said interface apparatus outputs and changes said information of said tagging system after said step of reading said information from said tagging system.

9. A method for preventing miss-process in a semiconductor wafer transfer system, said method comprising:
transferring a pod with a plurality of wafers therein and a tagging system thereon to a standardized mechanical interface (SMIF) apparatus;
sending a first signal to said a processing tool to request to lock said pod;
locking said pod on said standardized mechanical interface (SMIF) apparatus;
reading information from said tagging system by a tag reader mounted on said standardized mechanical interface (SMIF) apparatus;
sending a second signal to a processing tool to request to check whether said processing tool is ready;
checking whether a processing tool is ready; and
transferring said wafers to said processing tool if said processing tool is ready.

10. The method according to claim 9, further comprising said tag reader mounted on said interface apparatus outputs and changes said information of said tagging system after said step of reading said information from said tagging system.
